(19) United States
(12) Patent Application Publication
(10) Pub. No.: US 2024/0011466 A1
(43) Pub. Date: Jan. 11, 2024

(54) SYSTEM FOR ACCELERATING WIND TURBINE ROTATION

(71) Applicants: Waldemar PISKORZ, Koden (PL); Tomasz Tadeusz PISKORZ, Koden (PL); Ireneusz PISKORZ, Koden (PL); Krzysztof PISKORZ, Koden (PL)

(72) Inventors: Waldemar PISKORZ, Koden (PL); Tomasz Tadeusz PISKORZ, Koden (PL); Ireneusz PISKORZ, Koden (PL); Krzysztof PISKORZ, Koden (PL)

(21) Appl. No.: 18/038,430

(22) PCT Filed: Nov. 23, 2020
(86) PCT No.: PCT/IB2020/061052

§ 371 Date: May 23, 2023

(51) Int. Cl. F03D 9/17; F03D 3/00; F03D 15/10

(52) U.S. Cl. CPC F03D 9/17; F03D 3/005; F03D 15/10; F05B 2260/422; F05B 2260/4023

(57) ABSTRACT

A system for accelerating turbine rotation characterised in that on the upper end of an elongated rotor shaft there is an irreversible transmission (3) installed, with which there is connected a gearmotor (4) with an electric motor connected by a unidirectional clutch (6) with a pneumatic motor (7) which, in turn, is coupled with a magnetic motor (8).

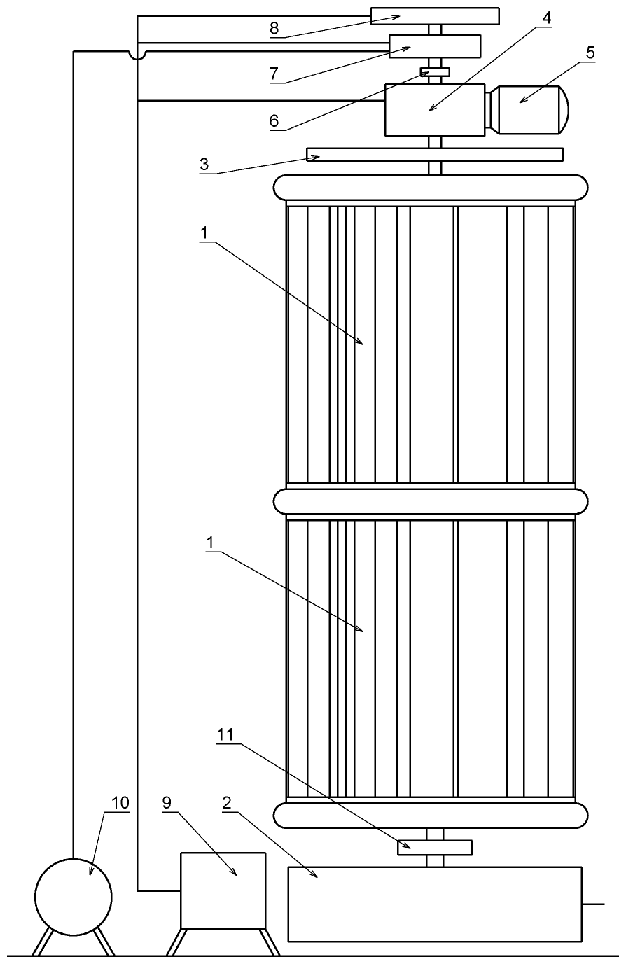

The invention relates to a system for accelerating rotation of a wind turbine with a rotor having vertical rotation axis.

From application PL422292 there is known a wind power plant comprising a turbine with vertical rotation axis and a generator. The rotor on its upper conical part is equipped with a lid functioning as an air tank.

The system according to the invention is characterised in that on the upper end of an elongated shaft there is an irreversible transmission connected with a gearmotor having an electric motor connected by a unidirectional clutch with a pneumatic motor which, in turn, is coupled with a magnetic motor. Aforementioned motors together with a mechanism for connecting the generator are connected with a controller which controls the connection of the motors to the shaft, disconnection of the generator, and the operation of the motors. Moreover, the pneumatic motor is connected with a compressed air tank filled by a compressed air installation connected with the turbine generator.

The system is used in cases when the wind is temporarily too low to provide force sufficient for a nominal rotation speed. The turbine might be accelerated by using one of the three motors, whereby the pneumatic motor is connected or disconnected depending on the filling level of the compressed air tank. All engines can work simultaneously or each of them individually. The turbine, when accelerated, returns energy input with a surplus, which constitutes major advantage of such a solution. The system according to the invention increases the potential of the wind turbine because the system allows energy to be stored.

Additionaly the system by using several different types of engines simultaneously allows for continuous operation of the turbine.

The solution according to the invention is shown in its exemplary embodiment on the drawing presenting the general view of the system. The application covers any configuration of motors on the shaft, including single motors.

The wind turbine comprises two segments 1 with rotors having vertical rotation axis. The turbine is equipped with a slow-speed generator 2 with an inverter.

On the elongated shaft of the upper rotor there is an irreversible transmission 3 installed connected with a gearmotor 4 coupled with an electric motor 5. The gearmotor is connected by a unidirectional clutch 6 with a pneumatic motor 7 mounted also on the rotor shaft. Above the pneumatic motor 7 there is magnetic motor 8. Next to the generator 2 there is a controller 9 with which the motors 5, 7, and 8 and a mechanism 11 are connected. Additionally, the pneumatic motor 7 is connected with a compressed air tank 10.

The system works as follows: In low wind conditions rotation speed of the turbine is accelerated to about 50 revolutions per minute, whereby the generator 2 reaches its nominal power. At this moment the generator is disconnected from the rotator shaft using the mechanism 11. After the turbine rotation is accelerated, one of the motors 5, 7, and 8, which has been so far driving the turbine, is switched of, and the mechanism 11 connects the generator 2. The turbine rotates by its torque thus becoming a propeller, returning the energy input with a surplus depending also on the wind force. In case of a further lack of wind with an appropriate force revolution speed of the turbine decreases, generator 2 is disconnected, and the segments of the turbine are again accelerated to the nominal revolution speed.

The pneumatic motor and the magnetic motor can drive the turbine in continuous mode of operation.

1. A system for accelerating rotation of a wind turbine with rotors having vertical rotation axis comprising an electrical generator, characterised in that on the upper end of an elongated rotor shaft there is an irreversible transmission (3) installed with which there is connected a gearmotor (4) with an electric motor connected by a unidirectional clutch (6) with a pneumatic motor (7) which, in turn, is coupled with a magnetic motor (8), whereby the motors (5), (7), and (8) are connected with a controller (9) to which there is also connected a mechanism (11) for connecting the generator (2).

2. The system according to claim 1, characterised in that the pneumatic motor (7) is connected with a compressed air tank (10) which is filled by a compressed air installation, that is not shown on the drawing, connected with the generator (2) of the turbine.
